(19) United States
(12) Patent Application Publication
(10) Pub. No.: US 2003/0202208 A1
(43) Pub. Date: Oct. 30, 2003

(54) System and method for managing storage of data in printing devices

(76) Inventors: Douglas J. Mellor, Meridian, ID (US); Darren E. Binder, Boise, ID (US); David A. Walthall, Boise, ID (US); Charles K. Keyes, Boise, ID (US); Gregory A. Vaughn, Meridian, ID (US); Patrick W. Fulghum, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/136,918

(22) Filed: Apr. 30, 2002

(51) Int. Cl. G06F 15/00; B41F 1/00; G06K 1/00

(52) U.S. Cl. 358/1.16; 358/1.15

(57) ABSTRACT

A printing device stores data associated with a print job in a memory device. The print job or portions of the print job have an associated reference count(s) indicative of whether the print job or portions of the print job are write-protected. The reference count(s) is incremented and/or decremented responsive to printing of the print job. A control system is configured to permit the print job or portions of the print job to be overwritten with new data when the reference count(s) reach a particular value indicating to the control system that the print job or portions of the print job are no longer write-protected. As a result, memory capacity for print jobs (up to twice the memory capacity of conventional printing devices) and print speed performance improvements are realized over conventional printing devices.

### TECHNICAL FIELD

This invention relates to printing devices, and more specifically, systems and methods for managing storage of data associated with print jobs in printing devices.

### BACKGROUND

There are several ways to store data associated with print jobs in printing devices. For instance, some printing devices use an optional hard disk drive in combination with some type of random access memory (RAM) medium to store print data. The RAM is used to store the print job or portions of the print job (i.e., its data) as the data is fed to a print engine. Typically, the hard disk is used to store more voluminous print data and to prevent RAM from the burden of having to store repetitively used data, such as data associated with printing collated copies of multiple page print jobs. The hard disk serves to free-up RAM so that other print jobs can be received while printing the collated copies. The hard disk can also be used to store “held” print jobs, which are print jobs that remain stored in memory (the hard disk) after completion of a print job request. The RAM and hard disk memory approach is hereinafter referred to as a “RAM/hard disk memory system.”

Another approach used to store print jobs involves printing devices that only utilize RAM. In other words, there is no “hard disk” physical medium memory device used to store print data in RAM only printing devices. In such printing devices, it is usually necessary to segment the RAM into (i) a general RAM area and (ii) a RAM disk area. The RAM area exemplifies the aforementioned RAM, whereas the RAM disk area exemplifies the aforementioned hard disk. The RAM disk is in essence a virtual hard disk. Thus, the RAM and RAM disk operate in the same fashion as the RAM/hard disk memory system described above, except the RAM, in this instance, is segmented to serve as both a general RAM and a virtual hard disk, (hereinafter “RAM/RAM disk memory system”).

Whether using the RAM/hard disk or RAM/RAM disk memory systems, identical copies of the same print job (or portions of the print job) are maintained in both the general RAM and its respective hard disk and/or RAM disk when performing, for example, collated printing. Storing duplicate copies of the same print job (or portions of print jobs) is a double memory penalty. This is especially problematic in RAM/RAM disk memory system implementations where total RAM space is usually more limited than most RAM/hard disk memory systems. As a consequence, it is easier for printing devices to reach a “memory out” situation, i.e., when there is insufficient storage space for print data to be store in the RAM/RAM disk memory systems.

There are also many read and write transfers between the RAM and its respective hard disk and/or RAM disk; especially for collated print jobs. A speed penalty is incurred when reading and writing data back and forth from the general RAM to its respective non-volatile disk. In most instances, the speed penalty is greater in hard disk approaches, but in either case, the read/write penalty can negatively affect the print speed of a printing device.

### SUMMARY

The following discussion is directed to systems and methods for managing storage of data in printing devices. In one described implementation, a print job is stored in a memory unit of a printing device. One or more portions of the print job have one or more corresponding reference counts, respectively, indicative of whether the one or more portions of the print job are write-protected. The one or more reference counts are incremented and/or decremented responsive to printing of the print job. A control system permits the one or more portions of the print job to be overwritten with new data when the one or more corresponding reference counts, respectively, reach a particular value indicating to the control system that the one or more portions of the print job are no longer write-protected.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates various components of an exemplary printing device that can be utilized to implement some of the techniques described herein.

FIG. 2 is a block diagram illustrating components of a reference-counted memory system for an exemplary printing device.

FIG. 3 shows two different examples of the type of portions of a print job that can be write-protected by an associated reference count.

FIG. 4 illustrates a method for a reference-counted memory system used to process a non-collated print job: a single copy print job is illustrated.

FIGS. 5A and 5B illustrate a reference-counted memory system method implementation for multi-paged, multi-copy sets of a print job.

FIG. 6 illustrates a block diagram of a general RAM, such as memory unit shown in FIG. 2.

FIG. 7 illustrates a method for managing memory allocations in general RAM when reference-counting is used.

### DETAILED DESCRIPTION

The following discussion is directed to systems and methods for managing storage of data in printing devices. The subject matter is described with specificity to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Overview

The following exemplary implementations introduce the broad concept of using a reference count to write-protect one or more portions of print jobs stored in volatile memory. As used herein, a print job generally means a single batch of characters printed as a unit. A print job usually consists of a document; copies of the document; or collated copies of the document; each of which can be one page or multiple pages in length. If not expressly mentioned when the term “print job” is used, it is assumed that the term inherently includes data (in various forms) associated with the print job. A reference count refers to memory management techniques for making certain portions of memory inaccessible and rapid reclamation of such inaccessible memory, by maintaining a count on a number of pointers that reference a particular block of data.

Now, with the advent of reference counting used in conjunction with storage of print jobs, one or more portions of the print job can be stored in general RAM along with an associated reference count, which serves to write-protect the one or more portions of the print job for so long as the reference count remains above a certain level. By using reference counts in association with print jobs, it is also possible to avoid having to segment a RAM into general RAM and RAM disk segments. This advent also avoids the double-memory penalty incurred with conventional printing systems and as result permits printing of longer and/or more complex print jobs. In other words, higher capacity printing can be accomplished due to elimination of memory copies as performed in most conventional printing systems.

Exemplary Printing Device Architecture

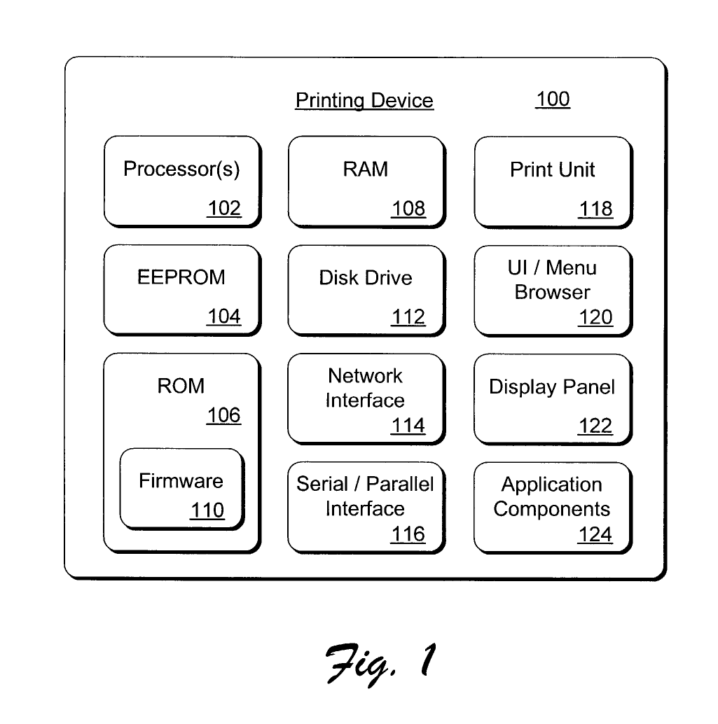

FIG. 1 illustrates various components of an exemplary printing device 100 that can be utilized to implement some of the techniques described herein. Printing device 100 includes one or more processors 102, an electrically erasable programmable read-only memory (EEPROM) 104, ROM 106 (non-erasable), and a random access memory (RAM) 108. Although printing device 100 is illustrated having an EEPROM 104 and ROM 106, a particular printer may only include one of the memory components. Additionally, although not shown, a system bus typically connects the various components within printing device 100.

Printing device 100 includes a firmware component 110 that is implemented as a permanent memory module stored on ROM 106. Firmware 110 is programmed and tested like software, and is distributed with printing device 100. Firmware 110 can be implemented to coordinate operations of the hardware within printing device 100 and contains programming constructs used to perform such operations.

Processor(s) 102 process various instructions (and/or logic) to control the operation of the printing device 100 and to communicate with other electronic and computing devices. The memory components, EEPROM 104, ROM 106, and RAM 108, store various information and/or data such as configuration information, fonts, templates, data being printed, and menu structure information. Although not shown, a particular printer can also include a flash memory device in place of or in addition to EEPROM 104 and ROM 106.

Printing device 100 also includes a disk drive 112, a network interface 114, and a serial/parallel interface 116. Disk drive 112 provides additional storage for data being printed or other information maintained by printing device 100. Although printing device 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer. The reference counting techniques described below may be implemented with either, but is particularly effective for systems that do not have a disk drive.

Network interface 114 provides a connection between printing device 100 and a data communication network. Network interface 114 allows devices coupled to a common data communication network to send print jobs, menu data, and other information to printing device 100 via the network. Similarly, serial/parallel interface 116 provides a data communication path directly between printing device 100 and another electronic or computing device. Although printing device 100 is illustrated having a network interface 114 and serial/parallel interface 116, a particular printer may only include one interface component.

Printing device 100 also includes a print unit 118 that includes mechanisms arranged to selectively apply an imaging medium such as liquid ink, toner, and the like to a print media in accordance with print data corresponding to a print job. Print media can include any form of media used for printing such as paper, plastic, fabric, Mylar, transparencies, and the like, and different sizes and types such as 8½×11, A4, roll feed media, etc. For example, print unit 118 can include an inkjet printing mechanism that selectively causes ink to be applied to a print media in a controlled fashion. The ink on the print media can then be more permanently fixed to the print media, for example, by selectively applying conductive or radiant thermal energy to the ink. Those skilled in the art will recognize that there are many different types of print units available, and that for the purposes of the present invention, print unit 118 can include any of these different types.

Printing device 100 also includes a user interface and menu browser 120, and a display panel 122. The user interface and menu browser 120 allows a user of the printing device 100 to navigate the printer's menu structure. User interface 120 can be indicators or a series of buttons, switches, or other selectable controls that are manipulated by a user of the printer. Display panel 122 is a graphical display that provides information regarding the status of printing device 100 and the current options available to a user through the menu structure.

Printing device 100 can, and typically does include application components 124 that provide a runtime environment in which software applications or applets can run or execute. Those skilled in the art will recognize that there are many different types of runtime environments available. A runtime environment facilitates the extensibility of printing device 100 by allowing various interfaces to be defined that, in turn, allow the application components 124 to interact with the printer.

General reference is made herein to one or more printing devices or other image forming devices, such as printing device 100. As used herein, “printing device” means any electronic device having data communications, data storage capabilities, and/or functions to render printed characters and images on a print media. A printing device may be a printer, fax machine, copier, plotter, and the like. The term “printer” includes any type of printing device using a transferred imaging medium, such as ejected ink, to create an image on a print media. Examples of such a printer can include, but are not limited to, inkjet printers, plotters, portable printing devices, as well as multifunction combination devices (MFP). Although specific examples may refer to one or more of these printers, such examples are not meant to limit the scope of the claims or the description, but are meant to provide a specific understanding of the described implementations.

Exemplary Reference-Counted Memory System for Printing Devices

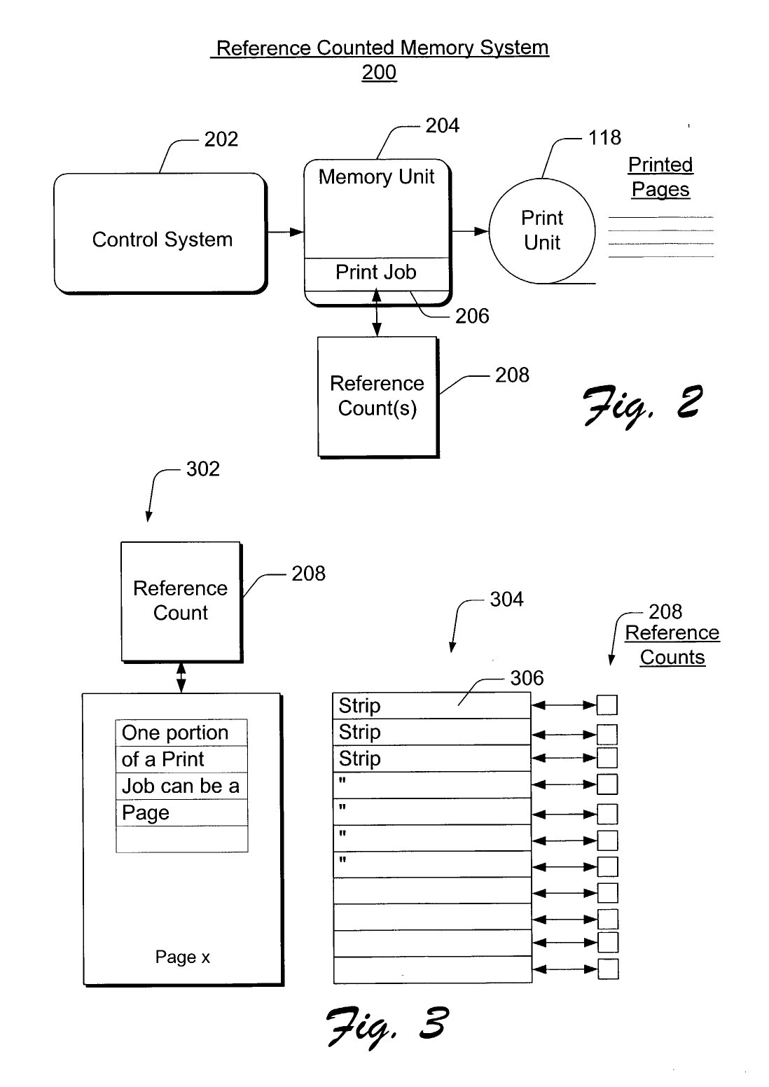

FIG. 2 is a block diagram illustrating components of a reference-counted memory system 200 for printing device 100. Reference-counted memory system 200 can include, or be implemented with, one or more of the following components: a control system 202, a memory unit 204, and print unit 118, which are one or more of the components from the exemplary printing device 100 (FIG. 1).

Control system 202 is implemented as a combination of either firmware (in the form of instructions or logic) 110 (FIG. 1) and/or software (in the form of instructions or logic) (where firmware and/or software is collectively referred to as i.e., “computer executable instructions”) running on processor 102 (FIG. 1). The computer executable instructions can be stored on some type of computer-readable media, such as ROM, flash, floppy disk, etc. Each of these components is described above with respect to the exemplary printing device 100 (FIG. 1). In other implementations, it is possible to use other processor based systems such as application specific integrated circuits (ASICs), programmable state-machines or other microprocessor based control systems. Control system 202 also serves as a memory management unit for the memory unit 204.

The memory unit 204 is typically implemented through the use of a volatile memory device such as RAM 108 (shown in FIG. 1), which is described above with respect to the exemplary printing device 100 (FIG. 1). In most implementations, memory unit 204 is a RAM only type printing device. Nevertheless, it should be noted, that the use of a RAM disk or hard disk is optional, and the use of reference counting in connection with print jobs does not preclude using such memory systems.

One or more portions of a print job, such as print job 206, can be sent directly from memory unit 204 (e.g., RAM) to print unit 118 (described above with reference to FIG. 1), without having to perform a hard disk or RAM disk read and/or write transfer. Printing multiple page collated copy print jobs traditionally required a hard disk or RAM disk to store data associated with the print job to free-up general RAM in between each successive collated copies. It is possible to completely eliminate the use of a hard disk or RAM disk. For multiple-page collated copy print jobs, this provides increased printing speed, and increased job size (capacity) capability over traditional approaches as well as less need to segment the RAM into sectors.

The one or more reference counts 208 are metadata that can be linked to a print job through a pointer table (not shown), a buffer (not shown, but part of memory unit 204) or reside within a portion the print job (such as its header). Each reference count is generated by the control system 202. Each reference count protects one or more portions of a print job until the one or more portions print job is completed. For instance, a collated print job causes the control system 202 to generate one or more reference counts, to ensure that one or more portions of the print job are write-protected in memory unit 204 for so long as it takes to complete printing the one or more portions of the print job.

In one exemplary implementation, if the reference count is positive, then one or more portions of the print job associated with the reference count are write-protected so long as the reference count remains positive. On the other hand, if the reference count reaches zero, then one or more portions of the print job associated with reference count can be cleared or overwritten with new data. Alternatively, one or more portions of the print job 206 could be cleared from memory unit 204, when the reference count reaches another particular value, not necessarily limited to zero, indicating to the control system 202 that the print job 206 is no longer write-protected. Additionally, the control system 202 ensures that the one or more reference counts 208 remain positive in the event that a command is received, from a host or user interface 120 (FIG. 1), to printing device 100, ordering the control system 202 to “hold” certain print jobs in memory unit 204 even after they have been successfully printed by the print unit 118.

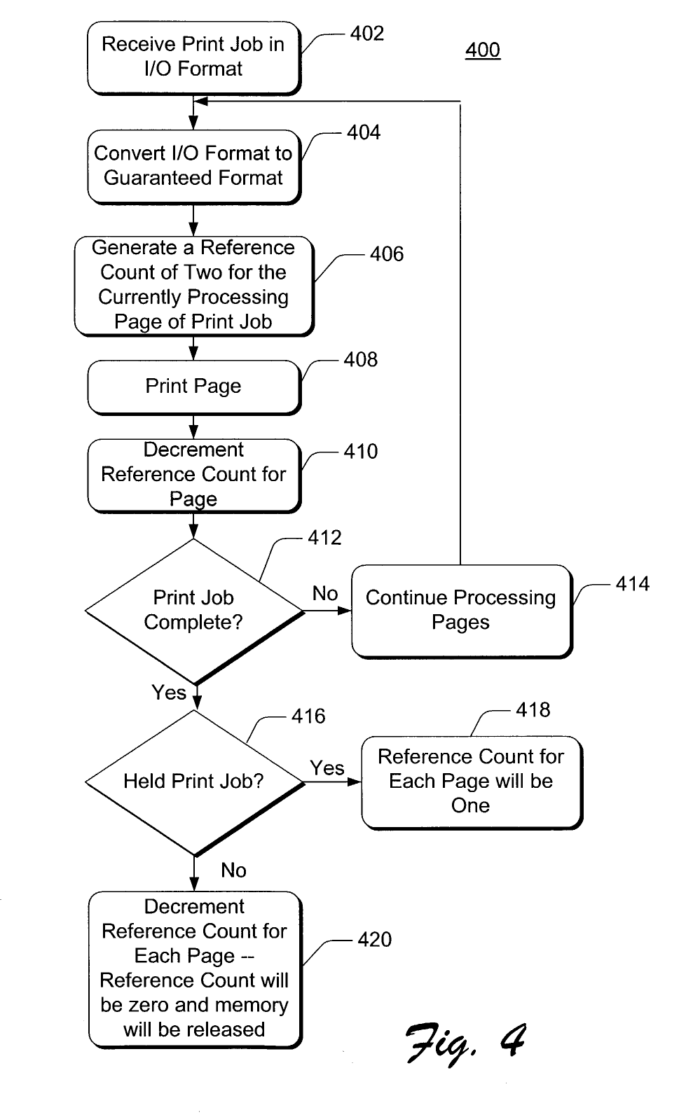

FIG. 3 shows two different examples of the type of portions of a print job that can be write-protected by an associated reference count. As used herein one or more portions (labeled in FIG. 3 as either a page or a strip) can be the entire print job, a page of a print job, or another smaller of larger combination of some portion of an entire print job(s). Note: A strip is subset of a page: being a horizontal or vertical slice of the page (see below). Example 302 represents one exemplary portion of a print job. The portion in example 302 is a page of print job 206. A reference count 208 associated with the page either write protects the page or if the reference count reaches zero, then the control system 202 is able to reclaim the memory location in memory unit 204 in which the page (portion of print job 206) is stored. Example 304 shows that one or more portions of a print job can also consist of strips 306. In one implementation, a page can consist of approximately forty (40) strips 306. Each strip 306 is therefore associated with a corresponding reference count 208. Thus, the aforementioned illustration shows that a portion of a print job can be multiple portions such as pages or strips, or may be the entire print job. As shall come apparent to those skilled in the art, reference counting multiple portions of a print job as opposed to the entire print job provides the benefit of freeing-up memory space at the completion of printing a portion of a print job rather than having to wait for an entire print job to complete printing, before freeing-up memory space.

Methods for Reference-Counted Memory System

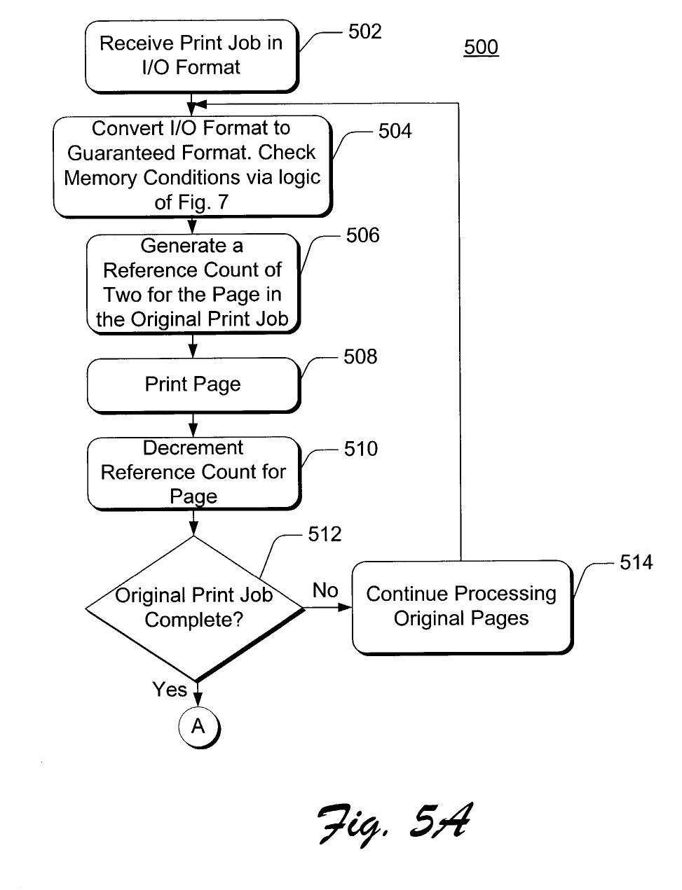

FIG. 4 illustrates a method 400 for a reference-counted memory system 200. This illustration shows how a regular non-collated print job is managed by reference-counted memory system 200. Method 400 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in firmware running on processor(s) 102.

At a block 402, printing system 100 receives a print job in I/O format. The I/O format is the format in which a host sends print jobs to its respective printing device, for instance a page description format.

At a block 404, control system 202 converts from I/O format to a guaranteed format. Guarantee means that the print unit 118 is made ready for printing. That is, control system 202 rasterizes and compresses the print job and restores the print job from I/O format to guaranteed format in memory unit 204.

At a block 406, control system 202 generates a reference count of two for each portion of the print job. In the exemplary illustration, the portion denominator is pages, but could easily be strips or some other proportion of the print job (including the print job itself). At this point each page of the print job is stored in memory unit 206 and has an associated reference count also stored in memory unit 204. Since, there is a reference count of two for the pages, the control system 202 recognizes that it cannot reclaim those locations of the memory unit for which these reference counts are associated.

At a block 408, a page of the print is printed by the print unit 118. The page is sent directly from memory unit 204 without having to load it in from a hard disk or RAM disk as discussed above.

At a block 410, the reference count associated with the print page is decremented. So the reference count will be one and because the reference count is still above zero for this page, the printed page will still remain in memory unit 204, write-protected.

At a decisional block 412, control system 202 determines whether the print job is complete. According to the no branch, at block 414 the printing process continues by repeating operations described in blocks 406 through decisional block 412 until the print job is complete.

At a decisional block 416, assuming the print job is complete, control system 202 determines whether the print job is a “held” print job. Held print jobs are those that are maintained in memory unit 204 even after the conclusion of a print job request, for later local use. According to the yes branch of block 416, the reference count for each page will be one and memory locations for these pages will not be released (see block 418). If on the other hand, according the no branch of decisional block 416, the print job is not a held print job, then control system 202 will decrement the reference count associated with each page of the print job, so that the reference counts will be zero. Accordingly, memory locations for these pages will be released (i.e., no longer write-protected).

It should be noted that the order of this method, as mentioned above could be different. For instance, in an alternative implementation, if the print job was a held print job, an extra reference count could be added as soon as the control system generates a reference count in step 406. Additionally, the control system 202 could release a page at the conclusion of the step 410 instead of waiting for the conclusion of entire print job to determine whether to decrement the print job as performed in block 420.

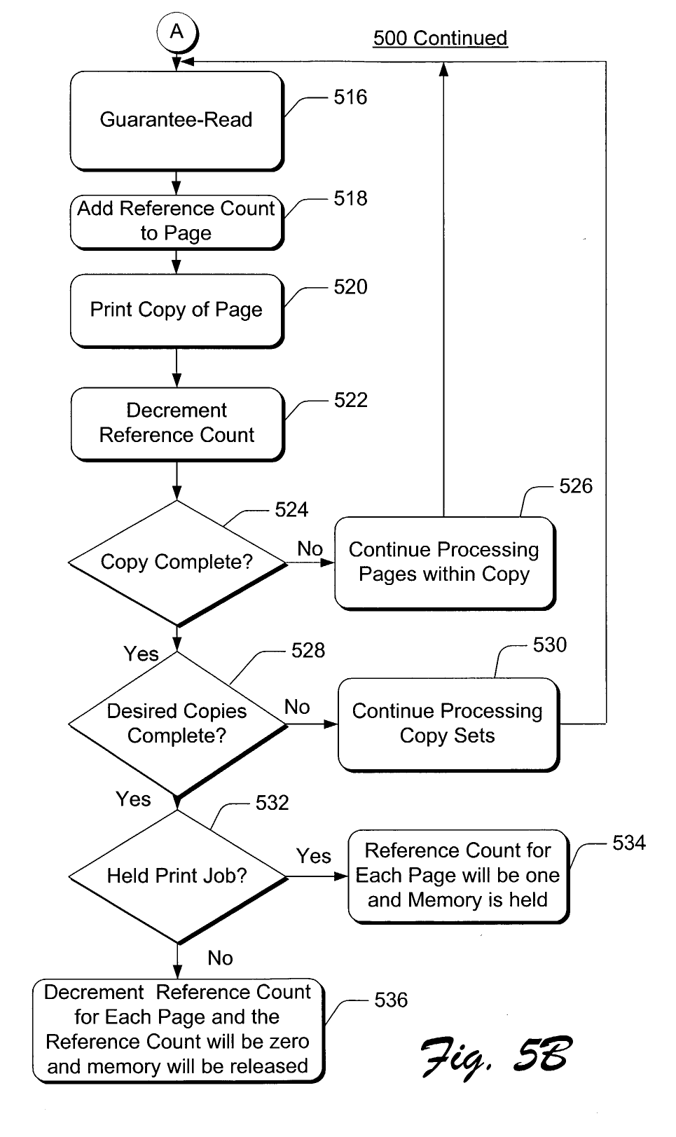

FIGS. 5A and 5B illustrate a method 500 for a reference-counted memory system 200. This illustration shows how a collated print job is managed by reference-counted memory system 200. Method 500 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in firmware running on processor(s) 102.

At a block 502, printing system 100 receives a print job in I/O format. The I/O format is the format in which a host sends print jobs to its respective printing device, for instance a page description format.

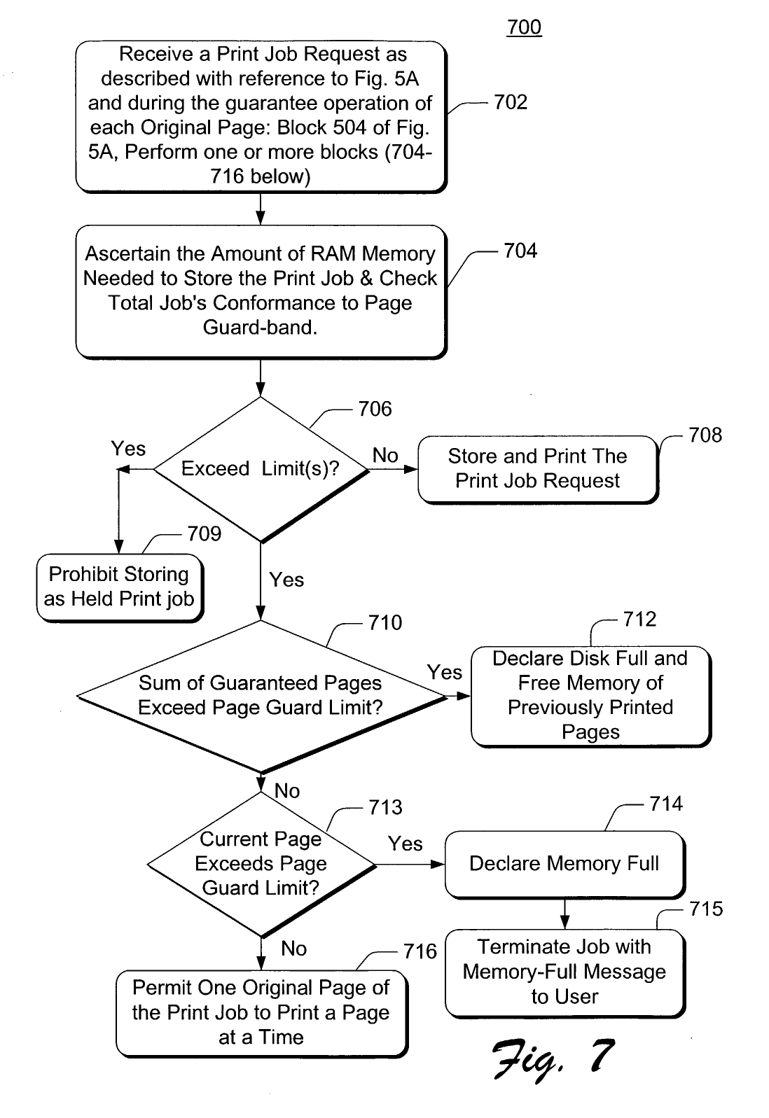

At a block 504, control system 202 converts from I/O format to a guaranteed format. That is, control system 202 rasterizes and compresses the print job and restores the print job from I/O format to guaranteed format in memory unit 204. In more general terms, guarantee means that the print unit 118 is made ready for printing. In this example, the print job is in the form of a multiple-page collated copy print job. Therefore, an original copy as well as collated copies of the original document will needed to be printed by printing system 102. Also, in block 504, control system 202 checks memory conditions via logic of FIG. 7 (blocks 702-716) described below with reference to FIG. 7.

At a block 506, control system 202 generates a reference count of two for a page of the original print job (i.e., the first page of the print job). Alternatively, a reference count could be associated with strips or some other proportion of the print job (including the print job itself). At this point at least one page of the print job is stored in memory unit 206 and has an associated reference count of two also stored in memory unit 204. The control system 202 monitors the reference counts and recognizes that it cannot reclaim the location within the memory unit for which the page is stored.

At a block 508, the page of the print job is sent from memory unit 204 directly to the print unit 118.

At a block 510, the reference count associated with the first page is decremented. So the reference count for this particular page will now be one and because the reference count is still above zero for this page, the printed page will still remain in memory unit 204; write-protected.

At a decisional block 512, control system 202 determines whether the original print job (the first completed document printed for the print job) is complete. According to the no branch, at a block 514 the printing process continues by repeating operations described in blocks 506 through decisional block 512 until all the pages have been printed by the print unit 118.

Referring to FIG. 5B, according to the yes branch of decisional block 516, once the initial first print out of the document job is completed, collated copies can be printed. Accordingly, in a block 516, the control system 202 begins a guarantee-read of the print job, again. At a block 518, control system 202 increments the reference count for each associated page of the print job. Accordingly, a reference count of two is realized and is associated (linked or assigned) with each page of the next copy of the print job.

At a block 520, a page of the print job is printed by print unit 118 and at a block 522, the reference count for that page is decremented. Now, the reference count for the printed page is one.

At a block 524, control system 202 ascertains whether all the collated copy is complete. If not, then according to the no branch, at a block 526, the printing method continues by printing the rest of the copy and repeating operations described in blocks 518-524 until all successive pages for a complete copy are printed.

Once copy is complete, at a block 528, control system 202 determines whether all sets (multiple copies) of the collated print job are complete. If not, then according to a block 530, operations described in blocks 516 through 528 will be repeated for each successive set of the multiple page, multiple copy, collated print job.

Assuming that at least one page for all sets of copies have been printed, then in a block 532, control system 202 determines whether the page is associated with a held print job or whether this is a quick copy (the print job is not meant to maintained in memory). If yes, then according to a block 534 the reference count for that particular page or pages will be left at one, and the control system 202 will inherently recognize that the particular page or pages are write-protected.

On the other hand, if in block 532, control system determines that the page should not be held, then according to a block 536, the reference count is decremented for each page making the reference count go to zero. Accordingly, locations in memory unit 204 formerly storing these page(s) can be overwritten with new data and/or cleared from memory unit 204.

Establish Limits for Reference-Counted Memory System

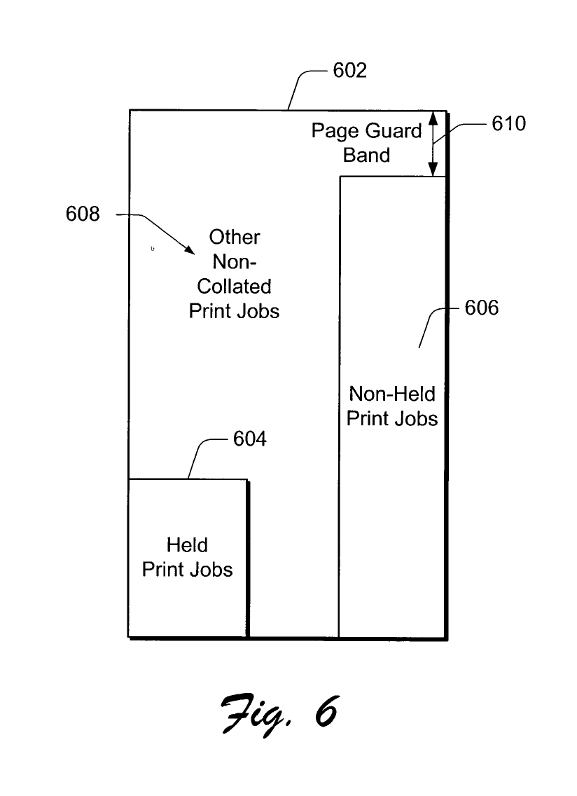

FIG. 6 illustrates a block diagram of general RAM 602, such as memory unit 204 shown in FIG. 2. general RAM 602 can include, or be implemented with, one or more dynamically adjustable limits for certain types of data that can be stored in the general RAM 602. For instance, held print jobs are conceptually limited to block 604 which represents a certain maximum percentage of the total general RAM 602. For example, an upper limit for held print jobs may be 25% of the total available memory space for general RAM 602. Non-held print jobs that are collated are conceptually limited to block 606, which in one implementation is a greater percentage of the total general RAM 602 than held print jobs block 602. In this example, for instance, the percentage may equal 75% of the total maximum available general RAM 602. Finally, the largest conceptual block is area 608, which represents a percentage limit on for all other types of print jobs, etc. This section can represent a total limit of, for example, 40% of all memory resources for general RAM 602.

A page guard-band 610 is used when general RAM 602 can not receive an entire print job for printing, because general RAM 602 does not have sufficient resources to store the print job. In this situation, the page guard-band 610 is used to ensure that printing of at least a single copy (original) of the print job can take place, but on a per page basis.

When the storage requirements to store all pages in the print job fits within the limitations of block 606 (non-held print jobs) (i.e., not violating the Page Guard Band 610), printing of the completed job is accomplished as previously illustrated in FIGS. 5A and 5B. In one mode of operation, every print job is started, because (i) it is more efficient, and (ii) the storage size of the total job is not known until all the pages of the job have completed the original guarantee (see block 704 of FIG. 7). In block 704 (to be described), a check on the status of the amount of memory stored in block 606 (non-held print jobs) is performed.

If continuing the mode of operation violates the page guard band 610, the mode is then shifted to the “page-at-a-time” mode via the following operations: (1) a disk full condition is declared, which disallows holding of the current and future page's memory beyond the printing; and (2) the reference count of pages in this job are reduced to zero and their memory is released. The following describes the operation of the memory management system after this mode is shifted.

So long as the worst case page (the page that requires the most memory storage) of a print job is less than the page guard, then the print job can be completed a page at time. Each time a page is printed in this scenario, the page is released, by decrementing the reference count associated with the printed page to zero and a next page is printed, etc., until all the pages are printed. In this situation, it is not possible to print collated printed jobs, but at least original copies of the print job can be printed. If for some reason, the worst case page exceeds the page guard-band 610, then instead of declaring the memory full, printing device must declare a memory out protocol, which can cause all held print jobs (and potentially other print jobs) to be released from memory.

FIG. 7 illustrates a method 700 for managing memory allocations in general RAM 602 when reference-counting is used. Method 700 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in firmware running on processor(s) 102.

At a block 702, printing device 102 receives a print job request. At each occurrence of the guarantee of an original page (block 404 or 504) the memory limitations are applied via the logic of block 702 through 716. Next, at a block 704, the memory space is determined only at guarantee time: and is therefore checked at each page's processing at block 704 (and appropriate action is taken per the logic of FIG. 7 to be described). In other words, the control system determines the size of the print job after completion of guarantee for each original page.

In a block 706, the control system 202 queries the general RAM 602 to determine if there is enough memory space to store print job or whether it exceeds certain upper limits. If the print job does not exceed any limits, then according to a block 708 the print job request is stored and printed.

On the other hand, if at block 706 the print job exceeds certain limits then the control system proceeds according to the yes branch of block 706. For example, if the print job request involves holding the print job, the control system determines whether print job exceeds an upper limit for the percentage of total memory that can be consumed by held print jobs. If at block 706 the print job cannot be held, then at block 709 the printing device declares to a user that the memory space for held print jobs is full, and the print job is not held in general RAM 602.

Referring back to block 706, if for example, the print job exceeds the amount of memory space needed to store it in general RAM 602, then in a block 710, control system 202 determines whether the sum of the currently-guaranteed pages exceeds the page guard-band 608. If the page exceeds the guard limit, then at a block 712 control system 202 declares the disk full and frees memory of previously print pages. If at block 710, the current sum of the currently-guaranteed pages does not exceed the guard page limit 608, then at a block 713, the control system 202 determines whether current page exceeds the page guard limit. If yes, then according to a block 714, the memory is declared full and at a block 715 the print job is terminated with a message declaring to the user the memory is full.

On the other hand, if at block 713 the current page does not exceed the page guard limit, then the printing device declares to a user that the memory is full, but that the print device can complete a single original of the print job. If the print job request is a collated print job, then the printing device 102 will not be able to complete collation, but can complete printing at least one original.

Accordingly, in a block 716, control system 202 permits one page of the print job to print a page at a time. This is performed by guaranteeing the first page, write-protecting the first page at a time though the use of a reference count, printing the first page, decrementing the reference count (releasing the page from memory), guaranteeing the next page and repeating these steps until all subsequent pages of the original print job request are completed.

It should be noted, that each limit for each virtual segmentation (e.g., 604-610) of general RAM 602 can be preset by a user or the manufacturer of printing device 102.

Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A printing device for printing a print job, comprising:
a memory unit configured to store a print job, wherein one or more portions of the print job have associated one or more corresponding reference counts, respectively, indicative of whether the one or more portions of the print job are write-protected, the one or more reference counts incremented and/or decremented responsive to printing the print job; and
a control system, configured to permit the one or more portions of the print job to be overwritten with new data when the one or more corresponding reference counts, respectively, reach a particular value indicating to the control system that the one or more portions of the print job are no longer write-protected.

2. The printing device as recited in claim 1, wherein the print job is a multiple-page collated print job.

3. The printing device as recited in claim 1, wherein each of the one or more portions of the print job is a page of the print job.

4. The printing device as recited in claim 1, wherein each of the one or more portions of the print job is a strip of a page of the print job, wherein each strip comprises a portion of a page.

5. The printing device as recited in claim 1, further comprising a print unit configured to print copies of the print job; wherein after the print unit has completed printing one or more portions of the print job, the reference count is decremented to the particular value indicating that one or more portions of the print job data are no longer write protected in the memory unit.

6. The printing device as recited in claim 1, further comprising a user interface configured to permit a user to send a command adding an extra value to the one or more reference counts ensuring that the control system continues to retain the one or more portions of the print job in the memory unit after completion of printing the one or more portions of the print job.

7. The printing device as recited in claim 1, further comprising a host device configured to permit a user to send a command adding an extra value to the one or more reference counts ensuring that the control system continues to retain the one or more portions of the print job in the memory unit after completion of printing the one or more portions of the print job.

8. The printing device as recited in claim 1, wherein one of the reference counts is metadata generated by the control system in response to receiving the print job from a host device.

9. A system, comprising:
a memory unit configured to store a multiple-page collated print job, the multiple-page collated print job having one or more associated reference counts that provide values indicative of whether to protect one or more portions of the multiple-page collated print job from being cleared from the memory unit;
a print unit configured to print copies the multiple-page collated print job; and
a control system, coupled to the memory unit and the print unit, configured to monitor the one or more reference counts and send the multiple-page collated print job from the memory unit to the print unit for printing the copies, the control system retaining the one or more portions of the multiple-page collated print job in the memory unit, until the one or more reference counts reach a particular value indicating that the one or more portions of the multiple-page collated print job can be cleared from the memory unit.

10. The system as recited in claim 9, wherein when the print unit has completed printing the one or more portions of the multiple-page collated print job, the reference counts associated with completed portions reach the particular value indicating that the multiple-page collated print job can be cleared from the memory unit.

11. The system as recited in claim 9, wherein the control system retains the multiple-page collated print job in the memory unit, after the print unit has completed printing the one or more portions of the multiple-page collated print job, if the reference counts associated with the completed one or more portions does not reach the particular value.

12. The system as recited in claim 9, further comprising a user interface input, configured to permit a user to add an extra count value to the one or more reference counts to ensure that control system retains the one or more portions of the multiple-page collated print job in the memory unit, after the print unit has completed printing the copies of the multiple-page collated print job.

13. The system as recited in claim 9, further comprising a user interface configured to permit a user to send a command in association with the print job ensuring that the control system continues to retain the multiple-page collated print job in the memory unit, when the print unit has completed printing the copies of the multiple-page collated print job.

14. The system as recited in claim 9, wherein the reference count is metadata generated by the control system in response to receiving the multiple-page collated print job from a host.

15. A system, comprising:
a random access memory (RAM) unit configured to store one or more portions of a multiple-page collated print job, the one or more portions of the multiple-page collated print job having associated one or more reference counts that provide values indicative of whether to protect the one or more portions of the multiple-page collated print job from being cleared from the RAM unit;
a print unit configured to print copies the multiple-page collated print job; and
a control system, coupled to the memory unit and the print unit, configured to send the multiple-page collated print job from the RAM unit to the print unit for printing the copies, wherein the control system is further configured to increment the one or more reference counts each time one or more portions of the multiple-page collated print job are guaranteed to be sent from the RAM unit to the print unit and each time the print unit completes printing one or more portions of the multiple-page collated print job decrement the one or more reference counts associated with the one or more portions.

16. The system as recited in claim 15, wherein when the print unit completes printing one or more portions of the multiple-page collated print job, the control system decrements one or more reference counts if the multiple-page collated print job is not a held job.

17. The system as recited in claim 15, wherein when the print unit completes printing all the copies of the multiple-page collated print job, the control system does not decrement the reference counts if the multiple-page collated print job is a held print job.

18. The system as recited in claim 15, wherein the one or more reference counts are incremented an extra value if the multiple-page collated print job is a held print job.

19. One or more computer-readable media having stored thereon computer executable instructions that, when executed by one or more processors, causes the one or more processors of a printing device to:
assign one or more reference counts to one or more associated portions of the print job;
store the one or more portions of the print job in a volatile memory device; and
protect the one or more portions of the print job from being deleted from the volatile memory device, if the one or more reference counts associated with those one or more portions of the print job remain above a certain level.

20. One or more computer-readable media as recited in claim 19, further comprising computer executable instructions that, when executed, direct the printing device to:
increment one of the one or more reference counts upon reading a portion of the print job from memory; and decrement one of the reference counts upon completing printing of the read portion of the print job.

21. One or more computer-readable media having stored thereon computer executable instructions that, when executed by one or more processors, causes the one or more processors of a printing device to:
store a multiple-page collated print job in a memory device;
assign one or more reference counts to one or more portions of the multiple-page collated print job;
print one or more portions of multiple collated copies of the multiple-page collated print job; and
retain one or more portions of the multiple-page collated print job in the memory device while printing the one or more portions of the multiple collated copies, by ensuring that the one or more reference counts associated with those one or more portions of the multiple-page collated print job remain above a particular level.

22. One or more computer-readable media as recited in claim 21, further comprising computer executable instructions that, when executed, direct the printing device to:
set the one or more reference counts to an initial level;
decrement the one or more reference counts after printing associated one or more portions of the multiple-page collated print job;
increment the one or more reference counts when initiating printing of a next set of the one or more portions of the multiple-page collated print job; and
decrement the one or more reference counts after associated one or more portions of the next set of the multiple-page collated print job has been printed.

23. One or more computer-readable media as recited in claim 21, further comprising computer executable instructions that, when executed, direct the printing device to release one or more portions of the multiple-page collated print job from the memory device, if one or more associated reference counts reach the particular level.

24. One or more computer-readable media as recited in claim 21, further comprising computer executable instructions that, when executed, direct the printing device to retain one or more portions of the multiple-page collated print job in the memory device, even after all multiple collated copies of the multiple-page collated print job have been printed, if the one or more reference counts remain above the particular level.

25. One or more computer-readable media as recited in claim 21, further comprising computer executable instructions that, when executed, direct the printing device to retain the multiple-page collated print job in the memory device, even after all multiple collated copies of the multiple-page collated print job have been printed, if a command is received directing the printing device to hold the multiple-page collaged print job the memory device.

26. One or more computer-readable media having stored thereon computer executable instructions that, when executed by one or more processors, causes the one or more processors of a printing device to:
store one or more portions of a multiple-page collated print job in a memory unit, the one or more portions of the multiple-page collated print job having associated one or more reference counts that provide a value indicative of whether to protect the one or more portions of the multiple-page collated print job from being cleared from the memory unit;
send the one or more portions of the multiple-page collated print job from the memory unit to the print unit for printing copies of the multiple-page collated print job;
print the one or more portions of the multiple-page collated print job;
monitor the reference count while printing the one or more portions of the multiple-page collated print job; and
retain the one or more portions of the multiple-page collated print job in the memory unit, until the associated one or more reference counts reach a particular value indicating that the one or more portions of the multiple-page collated print job can be cleared from the memory unit.

27. One or more computer-readable media as recited in claim 26, further comprising computer executable instructions that, when executed, direct the printing device to: decrement the one or more reference counts so that the one or more reference counts reach the particular value when the multiple-page collated print job has been successfully printed, indicating that the multiple-page collated print job can be cleared from the memory unit.

28. One or more computer-readable media as recited in claim 26, further comprising computer executable instructions that, when executed, direct the printing device to: retain the multiple-page collated print job in the memory unit, when the multiple-page collated print job have successfully been printed, if the one or more reference counts do not reach the particular value.

29. One or more computer-readable media as recited in claim 26, further comprising computer executable instructions that, when executed, direct the printing device to: permit a user to add an extra count value to the one or more reference counts to ensure that the multiple-page collated print job is retained in the memory unit, when the print unit has completed printing the copies of the multiple-page collated print job.

30. One or more computer-readable media as recited in claim 26, further comprising computer executable instructions that, when executed, direct the printing device to: permit a user to send a command in association with the print job ensuring that the multiple-page collated print job is retained in the memory unit, after completion of printing the multiple-page collated print job.

31. One or more computer-readable media as recited in claim 26, wherein the one or more reference counts are metadata generated in response to receiving the multiple-page collated print job from a host.

32. A system, comprising:
means for storing data associated with a print job, the print job having one or more associated reference counts indicative of whether one or more portions of the print job are write protected, the one or more associated reference counts incremented and/or decremented responsive to printing the print job; and
means for permitting one or more portions of the print job to be overwritten with new data when the one or more associated reference counts reach a particular value indicating that the one or more portions of the print job are no longer write protected.

33. One or more computer-readable media having stored thereon computer executable instructions that, when executed by one or more processors, causes the one or more processors of a printing device to:
receive a print job request;
determine how much memory space is needed to store the print job in memory;
query the memory space needed to store the print job exceeds an upper limit amount of total used space in memory that may be consumed by the print job in the memory unit;
if the print job exceeds the upper limit; and
permit one original of the print job to print a page at a time by: (i) writing in a first page with write protection; (ii) guaranteeing the first page for printing (iii) releasing the write protection, (iii) writing in the next page and repeating operations (i), (ii) and (iii) for all subsequent pages, until one original of the print job is completed.

34. One or more computer-readable media as recited in claim 33, further comprising computer executable instructions that, when executed, direct the printing device to, query the print job to ascertain whether a sum of guaranteed pages does not exceed a memory guard limit prior to permitting the print job to print a page at a time.

35. One or more computer-readable media as recited in claim 33, further comprising computer executable instructions that, when executed, direct the printing device to declare the memory full, if the print job exceeds the upper limit.

36. One or more computer-readable media as recited in claim 33, further comprising computer executable instructions that, when executed, direct the printing device to declare the memory full, if the print job exceeds the upper limit.

37. One or more computer-readable media having stored thereon computer executable instructions that, when executed by one or more processors, causes the one or more processors of a printing device to:
receive a first limit on the amount of total memory space that can be consumed by one or more held print jobs,
receive a second limit on the amount of total memory space that can be consumed by non-held print jobs where it is possible for the printing device to print the non-held print jobs, but not perform printing of multiple copies of the print job; and
receive a print job and query the whether the print job exceeds the first and/or second limits.

38. One or more computer-readable media as recited in claim 37, further comprising computer executable instructions that, when executed, direct the printing device to declare to a user that the memory space for held print job is full, if the received print job exceeds the first limit.

39. One or more computer-readable media as recited in claim 37, further comprising computer executable instructions that, when executed, direct the printing device to declare to a user that the memory space for non-held print job is full, if the received print job exceeds the second limit.

40. A system, comprising:
a volatile memory unit configured to store print jobs, the print jobs having an associated reference count if the print job is a held a print job or a multiple-page collated print job; and
a control system configured to monitor the volatile memory unit to ensure that no print jobs exceed a certain percentage of the volatile memory unit set for storing the print jobs.

41. The system as recited in claim 40, wherein the percentage of volatile memory set for held print jobs is less than a percentage of the volatile memory unit set for other types of print jobs.

42. The system as recited in claim 40, wherein the control system is further configured to permit printing of a multiple-page collated print job, even if the multiple-page collated print job exceeds the certain percentage of the volatile memory unit, by (i) storing at least one page, but less than all of the of the multiple-page collated print job in the volatile memory unit at a time, (ii) printing the at least one page, (iii) releasing the stored at least one page, and repeating (i), (ii) and (iii) until at least one original of the multiple-page collated print job is complete.

43. In a printing device, a method, comprising:
receiving a print job having multiple pages;
assigning a reference count to each page of the print job;
storing a page of the print job in memory;
printing a page of the print job; and
retaining the page in memory for so long as the reference count is above zero.
